(19) United States
(12) Patent Application Publication
(10) Pub. No.: US 2002/0013811 A1
(43) Pub. Date: Jan. 31, 2002

(54) Method and apparatus for controlling remote client computer

(76) Inventor: In-Gwang Kim, Seoul (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/912,360

(22) Filed: Jul. 26, 2001

(30) Foreign Application Priority Data
Jul. 26, 2000 (KR) 2000-42954

(51) Int. Cl. G06F 15/16

(52) U.S. Cl. 709/203

(57) ABSTRACT

A method for controlling a remote client computer. The method for performing a remote control of a client computer, which is applied to a remote control system, includes the steps of: a) at a remote control server, providing a remote control program to the client computer; b) at the remote control server, allowing the client computer to connect to the remote server based on a user identification and a password of the client S computer received from the client computer; and c) at the remote control server, performing the remote control of the client computer after discussing contents of the remote control through a chatting unit.

### FIELD OF THE INVENTION

The present invention relates to a method and apparatus for controlling a remote client computer; and, more particularly, to a method and apparatus for controlling a remote client computer in which a server controls a client computer performing download and installation of a remote control program, in response to a request signal from the client computer, or one of client computers is set as a server and the other is set as a client through a repeating server managing information about the client computers, and then the server controls the client.

### DESCRIPTION OF THE PRIOR ART

In remote control methods referred to as “PC anywhere” and “Dr. A/S”, a user should know Internet protocol (IP) address of a counterpart to which the user wants to connect. In particular, in order to perform the remote control through a telephone circuit, the user should confirm and inform to another computer to which the user wants to connect, its IP address.

### SUMMARY OF THE INVENTION

Therefore, it is an object of the present invention to provide a method and apparatus for controlling a remote client computer in which a server controls a client computer performing download and installation of a remote control program, in response to a request signal from the client computer, or one of client computers is set as a server and the other is set as a client through a repeating server managing information about the client computers, and then the server controls the client.

In accordance with an aspect of the present invention, there is provided a method for performing a remote control of a client computer, which is applied to a remote control system, comprising the steps of: a) at a remote control server, providing a remote control program to the client computer; b) at the remote control server, allowing the client computer to connect to the remote server based on a user identification and a password of the client computer received from the client computer; and c) at the remote control server, performing the remote control of the client computer after discussing contents of the remote control through a chatting unit.

In accordance with another aspect of the present invention, there is provided a remote control system for controlling a remote client computer, wherein the client computer is connected to a remote control server through a network, the remote control server comprising: a system monitoring unit for monitoring change on a display of the remote control server; a bitmap processing unit for generating a bitmap image based on a coordinates value of the change; a data compressing unit for compressing the bitmap image, thereby generating a compressed bitmap image; a data transmitting/receiving unit for receiving the compressed bitmap image from the data compressing unit and transmitting the compressed bitmap image to the client computer; an event processing unit for transmitting a keyboard/mouse event generated in the server to the data transmitting/receiving unit; a file transmitting unit for transmitting files necessary for the remote control of the client computer to data transmitting/receiving unit; and a chatting unit for transmitting control data to the client computer in the data transmitting/receiving unit.

In accordance with further another aspect of the present invention, there is provided a computer readable recording medium storing instructions for executing a method for performing a remote control of a client computer, which is applied to a remote control system, comprising the steps of: a) at a remote control server, providing a remote control program to the client computer; b) at the remote control server, allowing the client computer to connect to the remote server based on a user identification and a password of the client computer received from the client computer; and c) at the remote control server, performing the remote control of the client computer after discussing contents of the remote control through a chatting unit.

In accordance with still further another aspect of the present invention, there is provided a method for performing a remote control of client computers, which is applied to a remote control system, comprising the steps of: a) at a repeating server, providing a remote control program to a first and a second client computers; b) at the repeating server, determining whether the first and the second client computers are registered users based on based on user identifications and passwords received from the first and the second client computers, and allowing the first and the second client computers to enter a waiting room of a chatting unit; c) at the repeating server, informing the first client computer of an Internet protocol address of the second client computer; and d) at the first client, performing the remote control of the second client computer.

In accordance with still further another aspect of the present invention, there is provided a computer readable recording medium storing instructions for executing a method for performing a remote control of client computers, which is applied to a remote control system, comprising the steps of: a) at a repeating server, providing a remote control program to a first and a second client computers; b) at the repeating server, determining whether the first and the second client computers are registered users based on based on user identifications and passwords received from the first and the second client computers, and allowing the first and the second client computers to enter a waiting room of a chatting unit; c) at the repeating server, informing the first client computer of an Internet protocol address of the second client computer; and d) at the first client, performing the remote control of the second client computer.

### BRIEF DESCRIPTION OF THE DRAWINGS

Other objects and aspects of the invention will become apparent from the following description of the embodiments with reference to the accompanying drawings, in which:

FIG. 1 is a block diagram of a remote control system in accordance with one embodiment of the present invention;

FIG. 2 is a detail diagram of a remote control server in FIG. 1;

FIG. 3 is a flow chart illustrating a remote control method in accordance with one embodiment of the present invention;

FIG. 4 is a detail flow chart showing a remote control process in FIG. 3;

FIG. 5 is a block diagram of a remote control system in accordance with another embodiment of the present invention;

FIG. 6 is a detail block diagram of a repeating server in FIG. 5; and

FIG. 7 is a flow chart illustrating a remote control method in accordance with another embodiment of the present invention.

### PREFERRED EMBODIMENTS OF THE INVENTION

Hereinafter, embodiments of the present invention will be described in detail referring to the accompanying drawings.

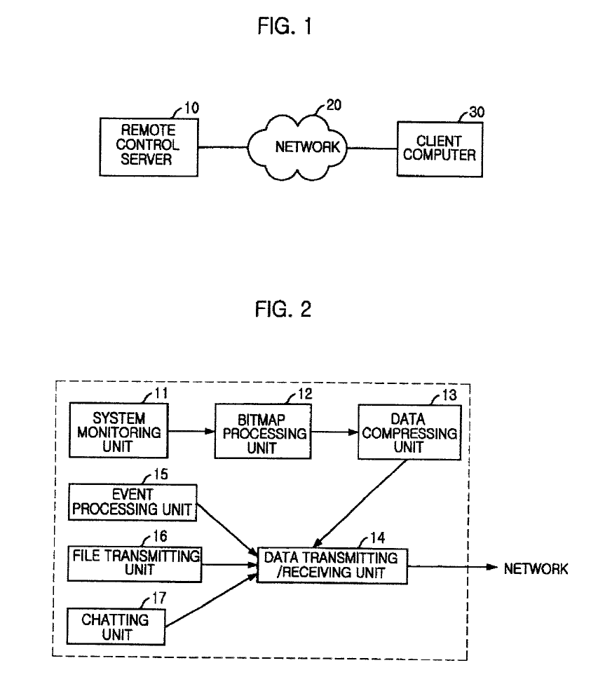

FIG. 1 is a block diagram of a remote control system in accordance with one embodiment of the present invention, to which a remote control method is applied.

Referring to FIG. 1, a remote control system includes a remote control server 10, a network 20 and at least a client computer.

The remote control server 10 controls the remote client computer 30 based on a request signal from the remote client computer 30. The client computer 30 downloads and installs a program for the remote control (hereinafter, which is referred to as “a remote control program”) and then is controlled by the remote control server 10.

FIG. 2 is a detail diagram of a remote control server in FIG. 1.

Referring to FIG. 2, the remote control server 10 includes a system monitoring unit 11, a bitmap processing unit 12, a data compressing unit 13, a data transmitting/receiving unit 14, an ir event processing unit 15, a file transmitting unit 16 and a chatting unit 17.

The system monitoring unit 11 monitors a change on a display unit (not illustrated) of the remote control server. The bitmap processing unit 12 receives a coordinates value of the change and generates a bitmap image. The data compressing unit 13 receives from the bitmap processing unit 12 and compresses the bitmap image. The data transmitting/receiving unit 14 transmits the compressed bitmap image to the client computer 30 through the network 20. The event processing unit 15 transmits a keyboard/mouse event generated in the remote control server to the data transmitting/receiving unit 14. The file transmitting unit 16 extracts files necessary for controlling the client computer 30 and transmits extracted files to the data transmitting/receiving unit 14. The chatting unit 17 transmits/receives information for the remote control to/from the user of the client computer 30.

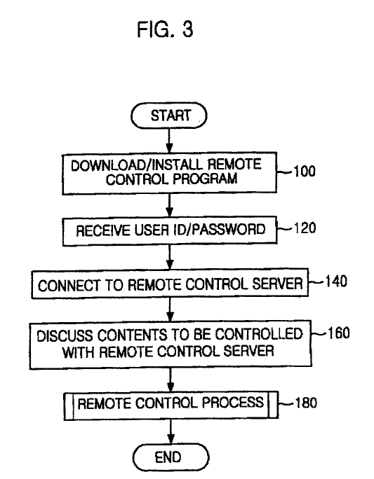

FIG. 3 is a flow chart illustrating a remote control method in accordance with one embodiment of the present invention.

First, the client computer 30 downloads and installs a remote control program at step 100, and receives a user identification (ID) and a password from the user at step 120. When the client computer 30 is connected to the remote control server 10 at step 140, the remote control server 10 discusses contents to be controlled with the user of the client computer, and then performs a remote control process at step 180.

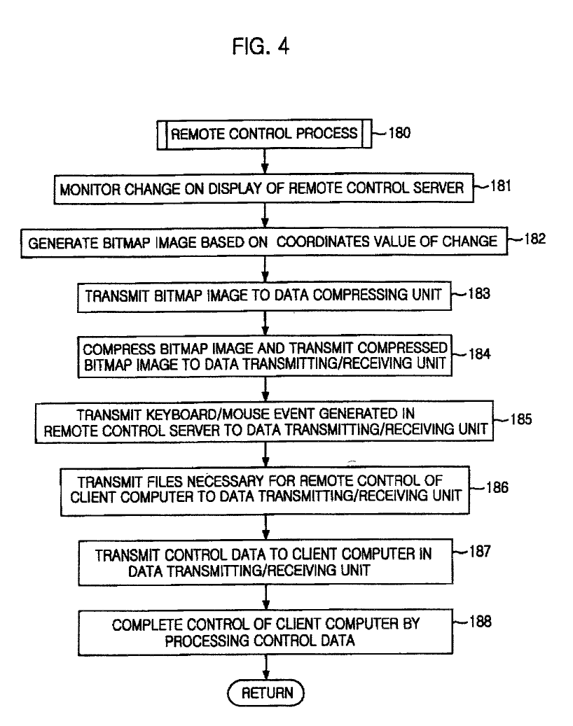

FIG. 4 is a detail flow chart showing a remote control process in FIG. 3.

A change on a display of the remote control server is monitored by the system monitoring unit 11 at step 181. When coordinates value of the change is transmitted to the bitmap processing unit 12, a bitmap image is generated at step 182. The bitmap image is transmitted from the bitmap processing unit 12 to the data compressing unit 13 at step 183, the bitmap image is compressed and transmitted to the data transmitting/receiving unit 14 at step 184. The event processing unit 15 transmits a keyboard/mouse event generated in the remote control server to the data transmitting/receiving unit 14 at step 185. The file transmitting unit 16 extracts files necessary for the remote control of the client computer 30 and transmits extracted files to the data transmitting/receiving unit 14 at step 186. Control data, i.e., the compressed bitmap image, the keyboard/mouse event, the files necessary for the remote control are transmitted to the client computer 30 through the network at step 187, and the remote control process is completed by the client computer's processing the received control data at step 188.

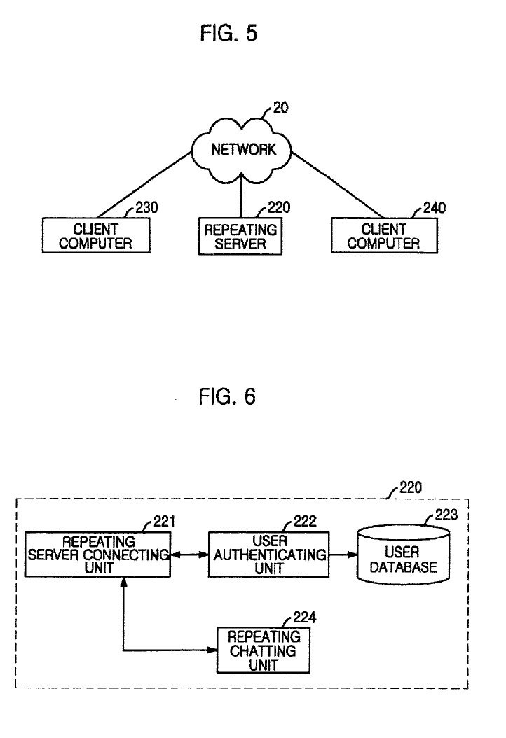

Hereinafter, a second embodiment of the present invention will be described in detail referring to FIGS. 5 through 7.

FIG. 5 is a block diagram of a remote control system in accordance with another embodiment of the present invention, to which a remote control method is applied.

Referring to FIG. 5, a remote control system includes a network 20, a repeating server 220 and client computers 230 and 240. The repeating server 220 manages user information, e.g., an Internet protocol (IP) address, a user identification (ID) and a password of each user and provides a room for conversation about the remote control, which is referred to as “a conversation room”. The client computers, a first client and a second client, download a remote control program from the repeating server 220, install it and then perform a connection to the repeating server 220. The client computers select one of them as a server and the other as a client to be controlled by the server.

FIG. 6 is a detail block diagram of a repeating server to which a remote control method in accordance with the present invention is applied.

Referring to FIG. 6, the repeating server 220 includes a repeating server connecting unit 221, a user authenticating unit 222, a user database 223 and a repeating chatting unit 224.

The repeating server connecting unit 221 receives user data. The user authenticating unit 222 authenticate the user based on user information stored on a user database 223 corresponding to the user data from The repeating server connecting unit 221, e.g., a user ID and a password. The repeating chatting unit 224 transmits and receives information necessary for the remote control to/from the client computers and determines which one of the client computers is to be a server to perform the remote control.

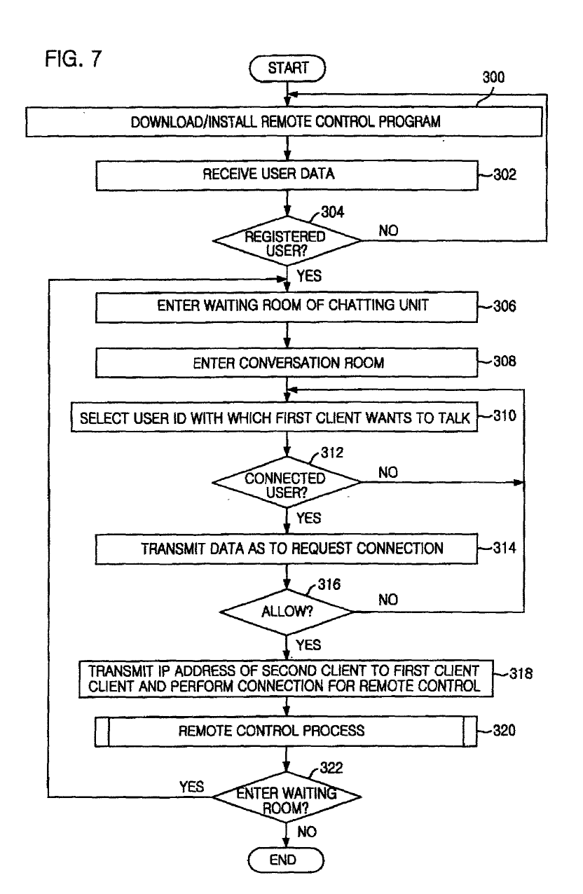

FIG. 7 is a flow chart illustrating a remote control method in accordance with another embodiment of the present invention.

The first and the second client computers download and install a remote control program after connecting to the repeating server 220 at step 300. If the user data, e.g., the user ID and the password are inputted at step 302, the user authenticating unit 222 of the repeating server 220 retrieves the user information based on the user ID and the password from the user database 223 and determines whether the user trying to connect is registered or not at step 304.

If the user is a rightful registered user, the first and the second client computers 230 and 240 can be entered to a waiting room of the chatting unit at step 306. If not, the process is returned to the step 300 to download/install the remote control program.

The first and the second client computers 230 and 240 enter a conversation room wanted to be entered at step 308. The first client computer 230 selects a user ID of the client computers with which the first client wants to talk at step 310. Then, the repeating server determines whether the selected client computer is connected or not at step 312.

If the selected client computer is not connected, the process repeats the step 310 to select a user ID. If so, the first client computer transmits a connection request data at step 314, and determines whether a connection is allowed or not at step 316. Hereinafter, for easy description, a user, which wants to be connected, is referred to a second client computer 240. If the connection is allowed, the repeating server 220 transmits an IP address of the second client computer to the first client computer and performs the connection for the remote control at step 318, then the first client computer 230 performs a remote control process of the second client computer at step 320. In other words, the first client computer 230 is the subject of the remote control and the second client computer 240 is the object of the remote control.

The remote control process at step 320 is similar with the remote control process mentioned above with reference to FIG. 4 except that the subject of the remote control is not a remote control server but the first client computer and the object of the remote control is the second client computer 240. Therefore, for only easy description, detailed description about the remote control process will be skipped.

In the remote control system in accordance with the present invention, the remote control server performs the remote control w based on the connection request signal received from the client computer performing download/install of the remote control, or performs the remote control through the repeating server managing the user information of the client computers. Therefore, using the present invention, processes for the connection can be effectively reduced. Even if there is no remote control server, the remote control can be performed.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A method for performing a remote control of a client computer, which is applied to a remote control system, comprising the steps of:
a) at a remote control server, providing a remote control program to the client computer;
b) at the remote control server, allowing the client computer to connect to the remote server based on a user identification and a password of the client computer received from the client computer; and
c) at the remote control server, performing the remote control of the client computer after discussing contents of the remote control through a chatting unit.

2. The method as recited in claim 1, wherein said step c) includes the steps of:
c1) monitoring a change on a display of the server, and transmitting a coordinates value of the change to a bitmap processing unit;
c2) generating a bitmap image based on the coordinates value of the change;
c3) compressing the bitmap image;
c4) transmitting a keyboard/mouse event generated in the remote control server to a data transmitting/receiving unit;
c5) transmitting files necessary for the remote control to the data transmitting/receiving unit; and
c6) at the data transmitting/receiving unit, transmitting control data to the client computer.

3. A remote control system for controlling a remote client computer, wherein the client computer is connected to a remote control server through a network, the remote control server comprising:
a system monitoring unit for monitoring change on a display of the remote control server;
a bitmap processing unit for generating a bitmap image based on a coordinates value of the change;
a data compressing unit for compressing the bitmap image, thereby generating a compressed bitmap image;
a data transmitting/receiving unit for receiving the compressed bitmap image from the data compressing unit and transmitting the compressed bitmap image to the client computer;
an event processing unit for transmitting a keyboard/mouse event generated in the server to the data transmitting/receiving unit;
a file transmitting unit for transmitting files necessary for the remote control of the client computer to data transmitting/receiving unit; and
a chatting unit for transmitting control data to the client computer in the data transmitting/receiving unit.

4. A computer readable recording medium storing instructions for executing a method for performing a remote control of a client computer, which is applied to a remote control system, comprising the steps of:
a) at a remote control server, providing a remote control program to the client computer;
b) at the remote control server, allowing the client computer to connect to the remote server based on a user identification and a password of the client computer received from the client computer; and
c) at the remote control server, performing the remote control of the client computer after discussing contents of the remote control through a chatting unit.

5. A method for performing a remote control of client computers, which is applied to a remote control system, comprising the steps of:
a) at a repeating server, providing a remote control program to a first and a second client computers;
b) at the repeating server, determining whether the first and the second client computers are registered users based on based on user identifications and passwords received from the first and the second client computers, and allowing the first and the second client computers to enter a waiting room of a chatting unit;
c) at the repeating server, informing the first client computer of an Internet protocol address of the second client computer; and
d) at the first client, performing the remote control of the second client computer.

6. The method as recited in claim 5, wherein said step d) includes the steps of:
d1) monitoring change on a display of the first client computer, and transmitting a coordinates value of the change to a bitmap processing unit;
d2) generating a bitmap image based on the change of the coordinates value;
d3) compressing the bitmap image, generating a compressed bitmap image and transmitting the compressed bitmap image to the data transmitting/receiving unit;
d4) transmitting a keyboard/mouse event generated in the server to a data transmitting/receiving unit;
d5) transmitting files necessary for remote control of client computer to the data transmitting/receiving unit; and
d6) at the data transmitting/receiving unit, transmitting control data to the client computer.

7. A computer readable recording medium storing instructions for executing a method for performing a remote control of client computers, which is applied to a remote control system, comprising the steps of:
a) at a repeating server, providing a remote control program to a first and a second client computers;
b) at the repeating server, determining whether the first and the second client computers are registered users based on based on user identifications and passwords received from the first and the second client computers, and allowing the first and the second client computers to enter a waiting room of a At chatting unit;
c) at the repeating server, informing the first client computer of an Internet protocol address of the second client computer; and
d) at the first client, performing the remote control of the second client computer.
